(19) United States
(12) Patent Application Publication
(10) Pub. No.: US 2023/0008057 A1
(43) Pub. Date: Jan. 12, 2023

(54) SYSTEM FOR REPRESENTING INSURANCE PRODUCTS AS GRAPHS

(71) Applicant: Two Sigma Insurance Quantified, LP, New York, NY (US)

(72) Inventors: Keith Alan Hendry, Hoboken, NJ (US); Nicholas Douglas Flanders, Palisades Park, NJ (US); Kai-Zhou Don Yang, Irvine, CA (US)

(21) Appl. No.: 17/859,825

(22) Filed: Jul. 7, 2022

Related U.S. Application Data
(60) Provisional application No. 63/219,079, filed on Jul. 7, 2021.

(51) Int. Cl. G06Q 40/08; G06F 8/41

(52) U.S. Cl. CPC G06Q 40/08; G06F 8/427

(57) ABSTRACT

A system for representing insurance products as directed graphs and transforms the directed graphs into graph object artifacts for execution. The system includes a compiler, an execution engine and a web-based runtime environment. The compiler transforms source code defining an insurance product as a directed graph into a plurality of nodes, where each node represents one of a computation and an input, and outputs a graph object artifact. The execution engine has an execution model derived from the graph object artifact that is loaded into memory and an application program interface that provides an interface to the web-based runtime environment. The web-based runtime environment provides a layer of abstraction between the execution engine and external services or systems.

### CROSS-REFERENCE TO RELATED APPLICATIONS

This application is related to and claims the benefit of U.S. Patent Application No. 63/219,079, filed Jul. 7, 2021, entitled “System for Representing Insurance Products as Graphs” which is incorporated herein in its entirety by reference.

### BACKGROUND

### Field

The present disclosure relates generally to systems that enable fast, reliable and efficient development and evolution of insurance products for SaaS environments. More specifically, the present disclosure relates to systems for representing insurance products as directed graphs capable of being transformed into graph object artifacts for execution.

### Description of the Related Art

Insurance products contain large amounts of complex logic, which makes them challenging to develop and maintain over time. Software implementations of insurance products need to ensure that an insurance carrier's business and regulatory requirements related to pricing, coverage availability, policy document creation, broker interaction, and risk appetite are satisfied for all jurisdictions in which the insurance carrier conducts business. The regulatory requirements for each of these jurisdictions are subject to frequent changes, which means that the maintenance of an insurance product remains costly for the entire lifetime of the insurance product.

The types of changes that are made to insurance products are often difficult to implement in general-purpose programming languages, as they frequently impact the core data model of the insurance product and can have cascading effects on many different components of the insurance product. Throughout the evolution of the insurance product, certain configuration requirements need to be upheld, such as the immutability, traceability and reproducibility of rate computations related to an issued insurance policy, and insurance carriers may be audited to ensure that their insurance products satisfy such requirements. Additionally, as data science and analytics have become increasingly important to the insurance underwriting process, the complexity of the domain has presented challenges related to extracting and storing useful, complete, normalized data from the insurance policies that an insurance carrier services.

The systems according to the present disclosure enable fast, reliable and efficient development and evolution of insurance products for SaaS environments.

### SUMMARY

The present disclosure provide embodiments of systems for representing insurance products as directed graphs and transforming the directed graphs into graph object artifacts for execution. In one exemplary embodiment, the system includes a compiler, an execution engine and a web-based runtime environment. The compiler transforms source code defining an insurance product as a directed graph into a plurality of nodes, where each node represents one of a computation and an input, and outputs a graph object artifact. The directed graph is defined using a meta-model. The meta-model includes a data model, at least one behavior component and at least one compute type. The data model includes structured data that is capable of being injected into the meta-model. The structured data may include a type of insurance product, a line of business associated with the insurance product, an entity associated with the insurance product, at least one feature associated with the insurance product, and one or more bounds associated with the insurance product. The at least one behavior component includes at least one computation element used to output a numeric value or structured data associated with the at least one compute type. In an exemplary embodiment, the compiler performs a series of transformations on the source code to output the graph object artifact. The series of transformations may include, for example, a parsing transformation that parses the source code grammar into an abstract syntax tree, a code generation transformation on the parsed source code, a type checking transformation on the source code generated by the code generation transformation, a scope resolution transformation on the source code, and an insurance hosting system transformation on the source code.

The execution engine has an execution model derived from the graph object artifact that is loaded into memory and an application program interface that provides an interface to the web-based runtime environment. The web-based runtime environment provides a layer of abstraction between the execution engine and external services or systems. The execution model includes at least one input node and at least one computation node. The execution engine may also include an execution engine environment populated with data associated with the insurance product, and an association of the execution engine environment data to the execution model. The execution engine executes a view from the execution model and the execution engine environment data that is externally observable via the web-based runtime environment.

### BRIEF DESCRIPTION OF THE DRAWINGS

Aspects and implementations of the present disclosure will be understood more fully from the detailed description given below and from the accompanying drawings of various aspects and implementations of the disclosure for explanation and understanding only;

FIG. 1 is an exemplary embodiment block diagram of a system for representing insurance products as graphs according to the present disclosure, illustrating a compiler that passes source code defining insurance products through a series of transformations and constructs an intermediate representation of graph object compiled artifacts associated with the insurance product for execution by an insurance hosting system;

FIG. 2 is an exemplary schematic representations of a meta-model for defining an insurance product as a directed graph;

FIG. 3 is an example of source code grammar used to generate a directed graph representing a commercial automobile insurance product;

FIG. 4 is an exemplary flow diagram for the compiler's passing source code through the series of transformations;

FIG. 5 is an exemplary embodiment of a scoping model defining rules imposed on the meta-model when constructing the directed graph;

FIG. 6 is an exemplary embodiment of a graph object artifact model output by the compiler of FIG. 1;

FIG. 7 is an exemplary schematic representation for generating an extension artifact execution model derived from a base graph object artifact plus extension graph object artifacts;

FIG. 8 is a block diagram of an execution engine forming a portion of the system of the present disclosure;

FIG. 9 is exemplary process of the execution engine handling a user request input via a service running on an insurance hosting system;

FIG. 10 is an exemplary execution model and an execution engine environment of the execution engine according to the present disclosure, illustrating a plurality of input and computational nodes from the directed graph of the insurance product being executed, a plurality of product data inputs for the nodes, and a plurality of cached computational values;

FIG. 11 is another exemplary execution model of the execution engine according to the present disclosure, illustrating a plurality of input and computational nodes from the directed graph of the insurance product being executed;

FIG. 12 is another exemplary execution model of the execution engine according to the present disclosure, illustrating a plurality of input and computational nodes from the directed graph of the insurance product being executed and an external node being executed;

FIG. 13 is an exemplary flow diagram of the execution engine's process for executing the computational nodes of FIGS. 11 and 12;

FIG. 14 is an exemplary validation process executed by the execution engine according to the present disclosure, illustrating a plurality of input and computational nodes from the directed graph of the insurance product being executed and a plurality of validation nodes associated with the input nodes;

FIG. 15 is an exemplary validation process executed by the execution engine in an unsafe mode;

FIG. 16 is an exemplary two dimensional table associated with each computation node in the meta-model, and illustrating values changing over time;

FIG. 17 is an exemplary block representation of a cluster of products in various host environments representing different instances of the products; and

FIG. 18 is an exemplary embodiment of execution model constructs organized into a stream of structured data that can be serialized and/or deserialized and can be read and interpreted by the compiler and the execution engine of the present disclosure.

### DETAILED DESCRIPTION

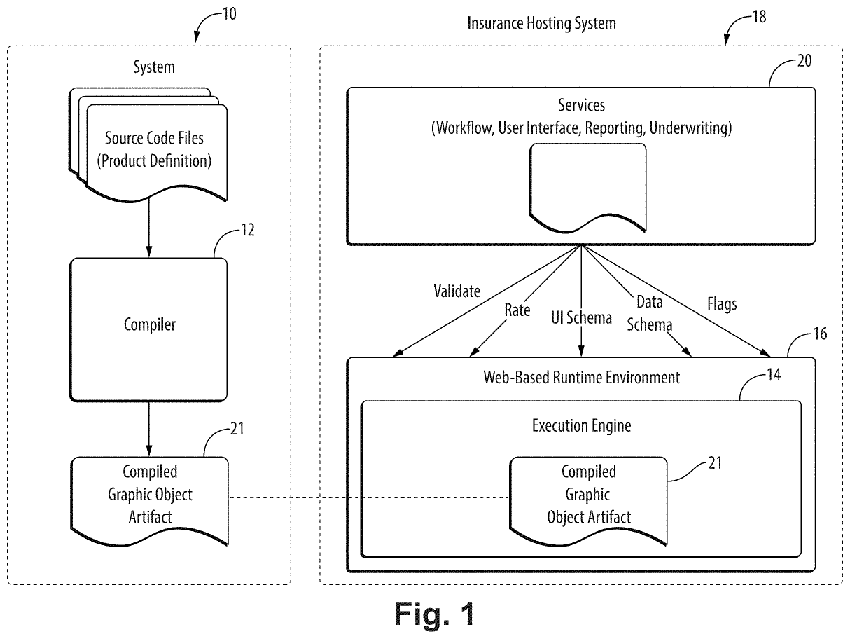

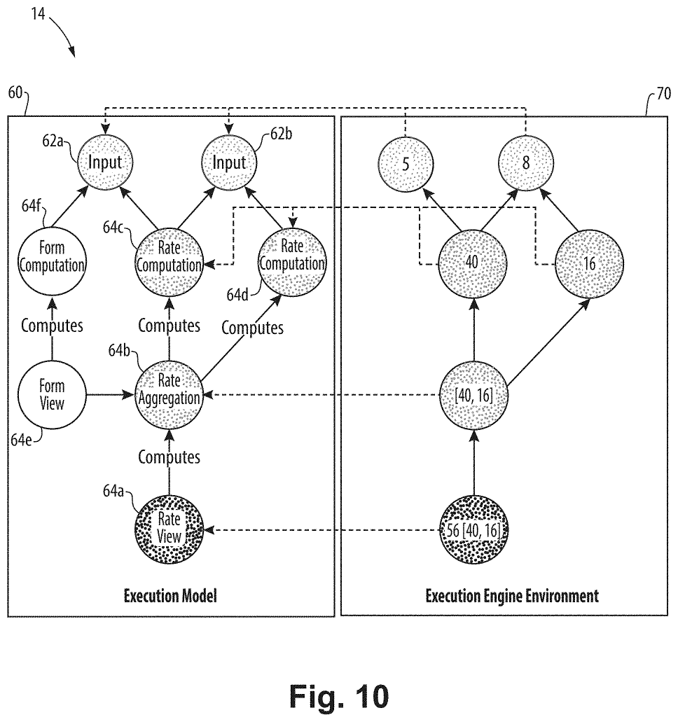

The present disclosure relates generally to systems for representing immutable insurance products as directed graphs capable of being transformed into graph object artifacts for execution. An exemplary embodiment of a system 10 according to the present disclosure is shown in FIG. 1. The system 10 includes a compiler 12, an execution engine 14 and a web-based runtime environment 16. Generally, the compiler 12 according to the present disclosure translates source code defining an insurance product as a directed graph into a collection of nodes representing either a computation or an input. For ease of description, the source code defining an insurance product as a directed graph may also be referred to herein as the “source code.” More specifically, for each insurance product the compiler 12 executes a series of transformations on the source code, and if the source code is syntactically and semantically valid, the compiler constructs an intermediate graph object representation of the relevant source code that can then be executed by the execution engine 14 via the web-based runtime environment 16. The execution engine 14 and runtime environment 16 may be part of an insurance hosting system 18 that may also include services 20, such as workflow services, user interface services, reporting services and insurance underwriting (UW) services. The execution engine 14 loads the execution model 60 into memory from the intermediate graph object representation of the insurance product and provides an interface to interact with an execution model 60, seen in FIG. 10. The runtime environment 16 provides a web-based interface, e.g., an HTTP interface, to the execution engine 14 and the insurance hosting system 18 that hosts a plurality of insurance products and provides the services 20. More specifically, the runtime environment 16 provides a layer of abstraction between the execution engine 14 and the services 20 provided by the insurance hosting system 18 which provides consistent interfaces across versions of the source code and provides various functionality for cooperating with the hosting infrastructure.

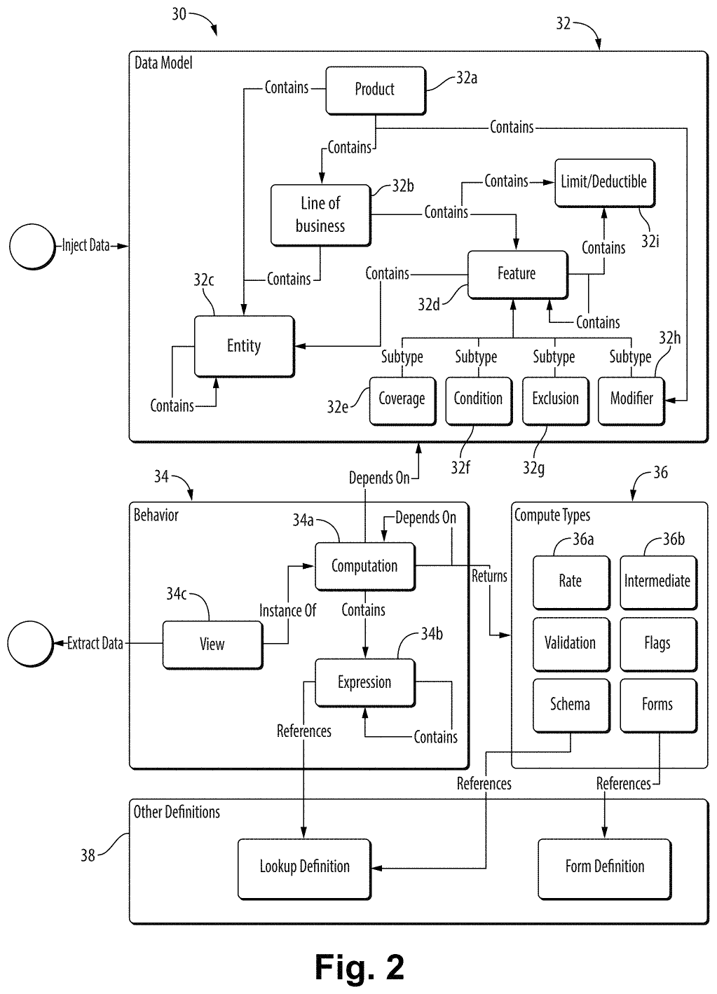

In the system 10 according to the present disclosure, each insurance product or a particular instance of an insurance product is represented as a directed graph that is defined using a meta-model. For ease of description, each insurance product or a particular instance of an insurance product may be referred to herein as an “insurance product.” An exemplary meta-model 30 for representing an insurance product is shown in FIG. 2. As shown, the meta-model includes a data model 32, behavior definitions 34, compute type definitions 36 and other definitions 38.

This exemplary meta-model 30 can be used to model all insurance product domains, such as commercial and personal insurance product lines. Generally, an insurance product is a unit of compilation that can be made up of one or more lines of business, such as commercial automobile, commercial general liability, commercial umbrella, etc., lines of business. The insurance product may also include one or more entities, features, limits, deductibles and/or behaviors. Entities typically model real word coverables or risks that insurance coverages then cover with given limit and/or deductible bounds. Non-limiting examples of entities include vehicles, boats, etc. Non-limiting examples of features include insurance coverages such as liability coverage and personal injury protection coverage. A non-limiting example of a limit includes a limit on liability coverage which is the max the insurer will payout on a liability claim. A non-limiting example of a deductible includes a deductible on liability coverage which if there is a liability claim, the insured will be responsible to pay before the insurer pays out up to the limit. Behaviors are added into the meta-model and cover pricing, validation, business rules, generating policy forms, user interface (UI) schema and/or dynamic behavior, and data ingestion and/or extraction. It is the one or more lines of business containing one or more entities, features, limits, deductibles and/or behaviors that form an instance of the meta-model 30.

Continuing to refer to the meta-model of FIG. 2, the data model 32 defines the kinds of structured data that may be injected into or provided to the meta-model 30 instance associated with a particular insurance product. Preferably, each insurance product contains one instance of this data model 32. The structure of the data model instance associated with an insurance product defines what input data the insurance carrier will need to collect from a customer in order to service that customer's insurance policy. At the root of the data model 32 is the insurance product 32a which can be made up of one or more lines of business 32b. In the insurance industry, a line of business represents an insurance line, such as general liability insurance or commercial automobile insurance. Within an insurance product line of business 32b there can be entities 32c which represent real world entities, such as vehicles, buildings, etc., that can be insured. Within an insurance product line of business 32b there can also be features 32d applied to the data model 32. The features 32d relate to insurance constructs, such as coverage 32e, conditions 32f, exclusions 32g and modifiers 32h. Insurance coverage 32e is the amount of risk or liability that is covered for an individual or entity. Insurance conditions 32f are situations under which the coverage applies or is required. Insurance exclusions 32g are insurance policy provisions that eliminate coverage for some types of risk. Insurance modifiers 32h are constraints around how an underwriter can modify pricing of an insurance product. As an illustration, for a commercial insurance product 32a, the commercial auto line of business 32b may contain a list of entities 32c, which in this illustration are vehicles that are covered by a feature 32d, which in this illustration is collision coverage. With such a commercial insurance product 32a, there may be bounds on the minimum and/or maximum of insurance coverage, i.e., feature 32d, which is provided by the insurer and that is described using limits and/or deductibles 32i. These limits and/or deductibles 32i can be applied to the data model 30 at either the feature 32d level or the line of business 32b level.

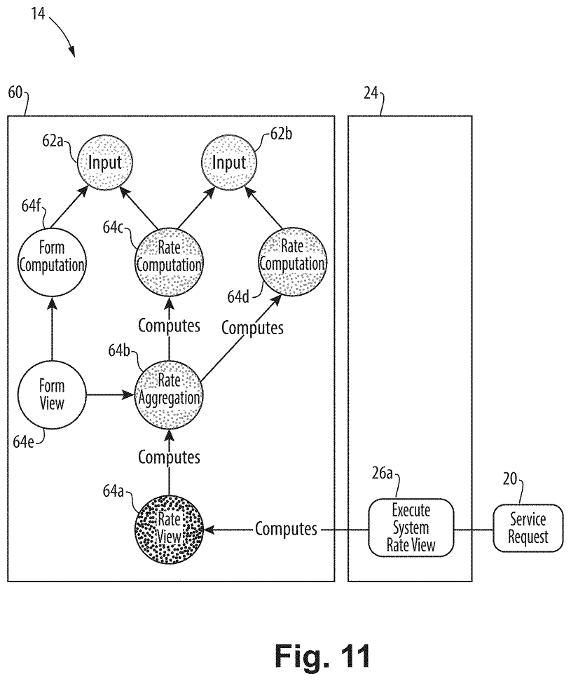

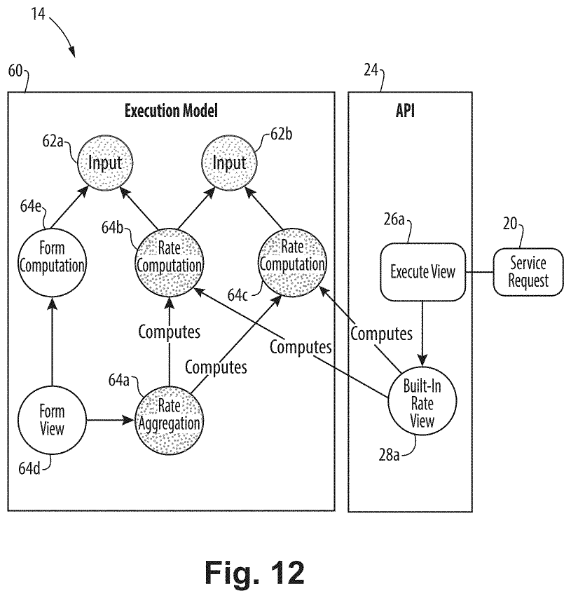

The behavior portion 34 of the meta-model 30 includes the computational elements of the insurance product 32a used to output primitive values or structured data to implement the logic required for the operations that the insurance product supports. These operations may include, for example, the pricing of an insurance policy, the generation of legally-binding policy documents, the validation of policy input data, etc., which are shown in FIG. 1 as interactions within the runtime environment 16. A computation 34a within the behavior component 34 of the meta-model 30 represents a single computed value that is used when implementing one or more product operations. Every computation 34a returns an instance of a single compute type 36 that is dependent upon which operation the computation 34a is implementing. The computation 34a references an expression 34b which is a single computational step that may depend on specific values or the results of other expressions. Non-limiting examples of expressions are addition, subtraction, multiplication, division, etc. Look-up expressions are a kind of expression that, given some input data from other expressions, can look-up values within a predefined table stored alongside the source code using the values of the given expressions as keys. A view 34c is a form or instance of a computation that is typically used to aggregate computations to expose the overall results of the insurance product 32a operations. A non-limiting example of a view 34c is a rating view 34c, seen in FIGS. 11 and 12, where the computation 34a would aggregate other computations with the return compute type 36a of “Rate.”

The system 10 according to the present disclosure uses a statically typed language and the result of computations 34a should be defined in the compute types 36 of the meta-model 30. As is common with all statically-typed programming languages, these types are attributes associated with all data values within a program that inform both a language user and the system 10 how to manipulate and interpret the value during both compilation and execution. The compute types can be predefined compute types 36, such as a built-in “Rate” type 36a, or user-defined types associated with intermediate values 36b.

In the system 10 according to the present disclosure, as noted above, each insurance product is defined using, for example, the meta-model of FIG. 2, which results in a structure that is a directed graph made up of a set of nodes, points or vertices connected by directed edges. It is noted that when the compiler 12 compiles the source code, the compiler verifies the dependencies of the directed graph, such that when there is a successful compilation of the source code, there is increased confidence that the particular insurance product is set up correctly in the system 10. Another reason for defining an insurance product as a directed graph is that relationships between meta-model elements, including products 32a, lines of business 32b, entities 32c, limits 32i, deductibles 32i, features 32d, and computations 34a, are preserved which maintains the semantics described in the source code in the compiled graph object artifact.

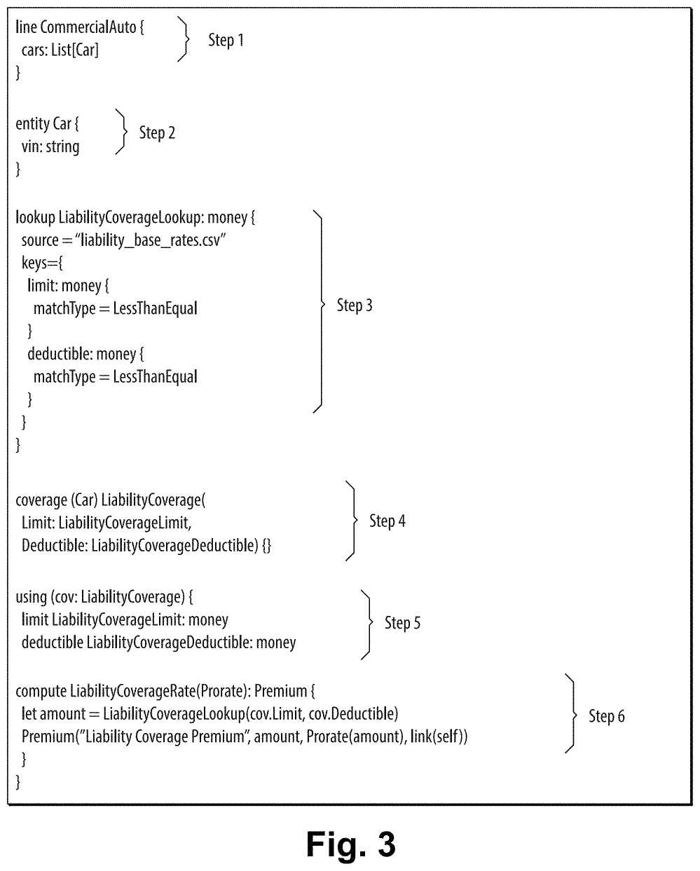

The grammar for the programming language in which the source code is written allows each insurance product to be defined as a directed graph derived from the meta-model elements and relationships, shown in FIG. 2 and described above. The grammar for the programming language used to generate the source code resembles a dataflow programming language as the dependencies are defined but are typically not wired explicitly. It is known that dataflow programming languages are typically used when the program, i.e., the source code, is for directed graphs and data flows between computational nodes of the directed graph. As is known, dataflow programming languages model a program as a directed graph of the data flowing between operations. Dataflow programming emphasizes the movement of data and models as a series of connections, where explicitly defined inputs and outputs connect operations that run as soon as all of its inputs become valid. A non-limiting example of a dataflow programming language is Lustre. An example of the grammar for the programming language used to generate the source code of the present disclosure is shown in FIG. 3. With reference to FIGS. 2 and 3, this example starts with a declaration of a line of business 32b called “CommercialAuto” which contains properties corresponding to zero or more entities 32c, which in this example is a single property that references a list of “Car” (Step 1). The source code then declares that the entity 32c “Car” has a single property “yin” of type “string” (Step 2). Below the “Car” declaration is a definition of a lookup function “LiabilityCoverageLookup” that takes a “limit” value and a “deductible” value 32i and returns a “money” value (Step 3). The values of the lookup table are contained in, for example, a “liability base rates.csv” file stored alongside the source code. The coverage definition 32e “LiabilityCoverage” under the lookup definition applies to each “Car” in the entity 32c list declared in the line of business 32b above and is associated with its own limit and deductible 32i (Step 4). This means that each “Car” in the entity 32c list has an individual liability coverage 32e with their own limits and deductible 32i. Below the coverage definition 32e is a “using” block with related declarations to a common model element. In this case, the common model element in the “using” block is the “LiabilityCoverage” feature 32d, which generally indicates that transitively the contents exist for each “Car” defined in the entity 32c list. Inside the “using” block exists a definition of the limit and deductible 32i and an insurance premium component “LiabilityCoverageRate” which is a computation 34a (Step 5). The calculation of the insurance premium component is defined in the source code as taking the limit and deductible, performing the look-up using the data file referenced in the look-up definition, and returning the result, i.e., the insurance premium amount. This calculation is performed by the execution engine 14 when it is populated with the data from a policy.

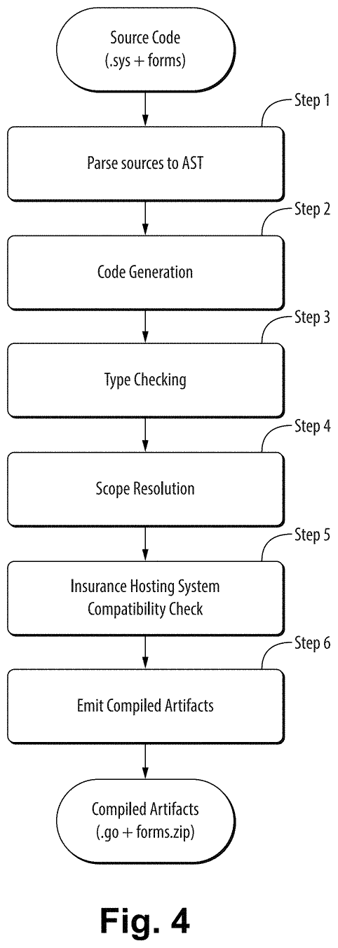

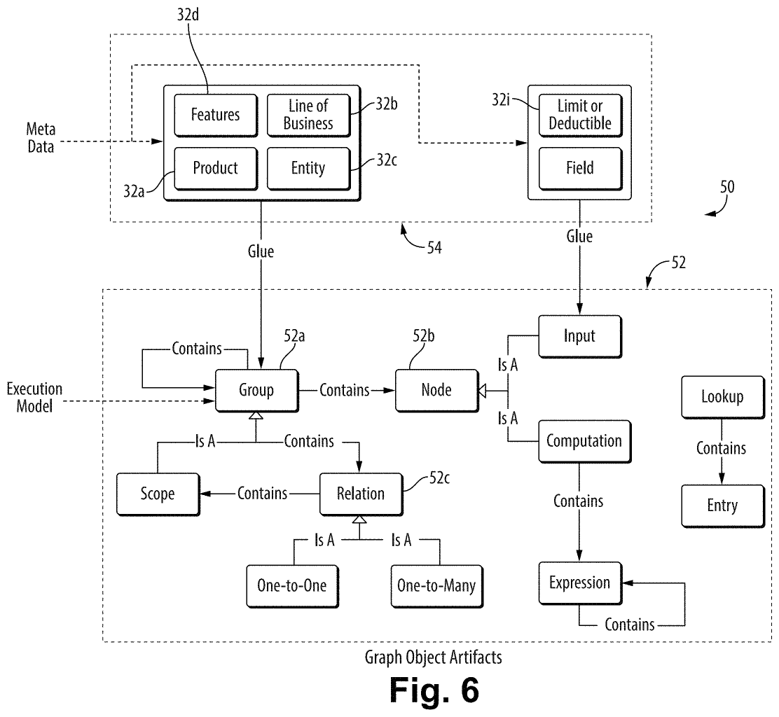

When compiling the source code, the compiler 12 according to the present disclosure passes the source code through a series of transformations, shown in FIG. 4, and eventually outputs or emits compiled artifacts as graph object artifact files 21 plus any associated form templates in, for example, zip files. A form template is a policy document file with placeholder values that the insurance hosting system 18 can fill in with actual values for a given insurance policy. A non-limiting example of a form template is a policy cover letter with a placeholder value representing the name of the policy holder. Initially, the compiler 12 parses the source code grammar into an abstract syntax tree (AST) and a symbol table is populated for type checking (Step 1). In step 2, the compiler 12 performs a code generation transformation on the parsed source code. In step 3, the compiler 12 performs a type checking transformation on the code generated in Step 2. In step 4, the compiler 12 performs a scope resolution transformation on the source code. In step 5, the compiler 12 performs an insurance hosting system 18 transformation on the source code. The compiler 12 then emits compiled graph object artifacts of the source code in step 6. As noted above, the compiled graph object artifacts are in the form of graph object artifact files plus any associated form templates in zip files. More specifically, the compiled artifacts are binary representations of elements in, for example, the graph object artifacts depicted in FIG. 6.

### Parser (Step 1)

The compiler 12 parses the source code grammar into an abstract syntax tree (AST) and a symbol table ready for type checking.

### Code Generation (Step 2)

As noted, the programming language used to create the source code according to the present disclosure is preferably a domain specific language (DSL), however other dataflow programming languages and other graph based languages may be used. Using a domain specific language makes describing the meta-model and grammar rules simpler than other dataflow programming languages and graph based languages. Using a domain specific language also permits the use of programmer designated syntax which can reduce the need to use boilerplate syntax and may reduce instances of programmer mistakes. As an example, a DSL may have a concise syntax for defining insurance underwriter (UW) rules which the compiler 12 can translate into the more verbose computation definitions that are required to implement all of the operations associated with that rule. This prevents redundant logic from being configured for every UW rule that is defined within a product. As another example, insurance products are often required to produce rating worksheets, which represent a human-readable list of calculation steps that were performed in order to arrive at a rating result for an insurance policy. A DSL allows the compiler to inspect the rating algorithm and to automatically generate the additional configuration required to represent that algorithm in a human-readable format, rather than requiring additional explicit manual configuration.

### Semantics

The semantic analysis phase verifies that the insurance product defined is valid according to the rules of the programming language and is capable of producing an insurance product execution model that can be successfully executed in the insurance hosting system 18. The semantic analysis phase of the compilation pipeline will be described with reference to Steps 3 and 4 in FIG. 4.

### Type Checking (Step 3)

The type checking process verifies that the types used and/or inferred in the source code exist and are used correctly. During the type checking process, the compiler 12 builds a symbol table that maps identifiers, e.g., the names of defined elements in the exemplary source code in FIG. 3, to types, e.g., the compute types 36 of the meta-model 30 shown in FIG. 2, within lexical scopes to check the data model 32 definitions, lookup table definitions and values, computation parameters and expressions, etc. of the meta-model 30. After this type checking stage, the individual definitions should be semantically valid.

### Scoping Resolution (Step 4)

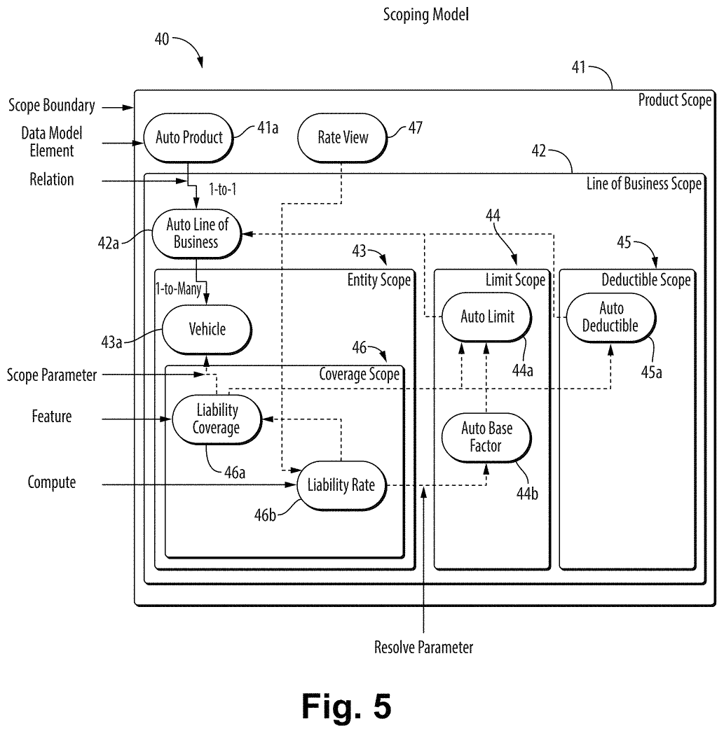

As previously stated, in the system 10 of the present disclosure, each insurance product is defined or represented as a directed graph of inputs and outputs. Relationships between entities 32c and features 32d may be one-to-one, one-to-maybe one, or one-to-many. These additional relationship cardinalities add extra complexities to the directed graphs, including increasing the difficulty of checking if dependencies are valid. A scoping model according to the present disclosure provides graph scoping rules that the compiler 12 can use to systematically check if the dependencies are valid and unambiguous given the relationships between elements in the product. In an exemplary embodiment, the graph scoping rules may include:
In the data model 32 described in the meta-model 30 of FIG. 2, any relationship between entities 32 creates a new child scope. It is noted that scopes hold or bound elements and/or entities 32c in the meta-model 30. However, a scope can also hold other scopes. A scope that is contained within another scope is referred to as a child scope, and the scope that contains the child is referred to as a parent scope. Child scopes may themselves contain additional scopes, which makes such a scope both a child and a parent. The relationships between entities 32c, lines of business 32b, and products 32a define the core structure of the data model 32. Each scope can be one of three types:
   One-to-One: exactly one instance of the scope is required for every instance of a parent scope;
   One-to-Maybe One: up to one instance of the scope is required for every instance of a parent scope; and
   One-to-Many: zero or more instances of a scope are required for every instance of a parent scope.
All child scopes contain the element that created it, i.e., the root element, and all elements in child scopes with the correct type for the given cardinality:
   Any one-to-one relationships get mapped to a singular instance of the declared type;
   Any one-to-maybe one relationships get mapped to an optional type, where optional types are unwrapped to a single optional if crossing many one-to-maybe one relationships;
   Any one-to-many relationships each get mapped to a list type, where it is possible to have lists of lists if crossing two one-to-many relationships
Scopable elements of the source code may include, for example; 1) features of the meta-model, such as coverages, conditions, exclusions and/or modifiers, and limits and/or deductibles, 2) computations, 3) validations, 4) underwriting rules, 5) export tables in for example rows or slices, and 6) entities in extensions. All scopable elements have a single scope parameter that references some entity 32c, line of business 32b, product 32a, or another scopable element. This scope parameter indicates that the scopable element should exist within every scope where the referenced element exists. Additionally, some scopable elements also support resolved parameters. Examples of scopable elements that support resolved parameters include features 32d and computations 34a. For scopable elements that support resolved parameters, the element should only be valid within scope instances that satisfy all of the dependencies that the resolved parameters indicate based on the type mappings described above (e.g., elements within a one-to-many child scope must be wrapped in a list type to be valid as resolved parameters within the parent scope).
If there is a single unambiguous element found that satisfies a resolved parameter, then this single unambiguous element is selected as the resolved parameter.
All resolved parameters should be valid for a scopable element to be attached to the scope instances referenced by the scope parameter.
   A non-limiting example of the implementation of the rules of the exemplary graph scoping model 40 to a simple auto insurance product instance of the meta-model is shown in FIG. 5. With this exemplary graph scoping model and using the exemplary graph scoping rules set for above, the following product scopes 41 can be created:
Initially, a line of business scope 42 and an entity scope 43 are created from the data model 32, shown in FIG. 2, of the auto insurance product. The line of business scope 42 is a child scope of the product scope 41, and the entity scope 43 is a child scope of the line of business scope 42. For the line of business scope 42, the auto insurance product definition contains a reference to an auto line of business 42a which creates a one-to-one scope with the product scope 41 to contain the line of business scope 42. For the entity scope 43, the auto line of business definition 42a contains a list of Vehicle instances 43a, where Vehicle is an entity 32c shown in FIG. 2. This list of Vehicle instances creates a one-to-many scope with the line of business scope 42 that references the list of Vehicles 43a.
The auto limit scope 44 and the deductible scope 45 are child scopes of the line of business scope 42. Both the auto limit 44a and the auto deductible 45a are scoped to the auto line of business 42a. These two elements cause the child scopes limit scope 44 and deductible scope 45 to be created, respectively.
The coverage scope 46 is a child scope of the entity scope 43. The liability coverage 46a is scoped to the vehicle entity, which is referenced by the list of vehicles 43a in the entity scope 43. The liability coverage 46a also depends on the auto limit 44a and the deductible 45a. The coverage scope 46 is a child scope of the entity scope 43 because the liability coverage 46a can be scoped to each vehicle within the list of vehicles 43a in the one-to-many entity scope 43, and the liability coverage 46a can resolve a single instance of the auto limit 44a and the auto deductible 45a. The auto limit computation 44a and the deductible computation 45a can be resolved because a single instance of the auto limit computation and the auto deductible computation 45a can be resolved from the line of business scope 42 which is a parent scope of the entity scope 43.
An auto base factor computation 44b is scoped directly to the auto limit 44a, which means that it exists inside the limit scope 44, which is a child scope under the line of business scope 42. It is noted that the auto base factor 44b is, for example, a single instance of a base rate or premium that can be accessed within all instances of the liability coverage scopes 46, as only a single instance of the limit scope 44 exists within the auto insurance product because none of the parent scopes of the limit scope 44 are one-to-many or one-to-maybe one.
The liability rate computation 46b in the coverage scope 46 is scoped to the liability coverage 46a but also depends on the auto base factor 44b. Because the auto base factor 44b appears exactly once in the parent line of business scope 42, the liability rate computation 46b can be resolvable from the coverage scope and can be placed in the coverage scope, which is a child scope under the entity scope. It is noted that the liability rate is, for example, a rate or premium associated with a single liability coverage instance 46a for a single vehicle within the list of vehicles 43a in the entity scope 43.

There may be instances when declaring dependencies that adhere to the scoping model 40 described above may be tedious. One such example of a tedious task is aggregating all computations, e.g., computations 34a seen in FIG. 2, of the meta-model 30 that represent calculations of a specific compute type 36. For example, aggregating all computations 34a that return a rate compute type 36 to get a total rate or premium. To aggregate these computations using the scoping model 40, the dependencies to all computations which return the type would typically be manually added. To remove the need to manually add the dependencies, a query parameter “All[ ]” function may be invoked to search the current scope and all child scopes for one of two things:
All[Instance] searches for all instances of a compute with the given name, such as LiabilityCoverageRate in FIG. 5; or
All[Type] searches for all instances of a compute which returns the given type 36, such as Rate in FIG. 2.
   One such example of an All[ ] parameter can be seen in the rate view 47 of FIG. 5. The rate view 47 is an instance of a view computation 34c that aggregates all instances of the Rate compute type 36. The All[ ] parameter allows the compiler 12 to depend on all instances of Rate computations in child scopes, which in this example is the liability rate 46b, without explicitly specifying all the individual Rate computations. The compiler 12 resolves all paths to the relevant nodes in the directed graph and generates an error if a cyclic dependency is introduced. At runtime, the valid instances of computations 34a which return the desired compute type 36a are flattened into a list. The result of the scope resolution process in Step 4 of FIG. 4 is a graph model, which is an in-memory representation of the insurance product that is augmented with scope information and is later used to generate an execution model 60 instance in Step 6. The graph model 50 splits meta-model elements, including instances of entities 32c, lines of business 32b, products 32a, features 32d, limits and deductibles 32i, and computations 34a from FIG. 2, into all realized scopes, after which the compiler 12 is ready to emit to an intermediate representation of the insurance product into a binary representation that maps to the execution model 30. The execution model 60 is the model that the compiler 12 emits as a graph object artifact and the execution engine 14 uses to execute. This is useful because scopable elements may map across many scopes and dependencies could have different paths in each scope.

### Insurance Hosting System Compatibility Check (Step 5)

In order to operate with the insurance hosting system 18, the compiler 12 performs an additional semantic analysis that checks to ensure that the source code includes entities 32c specific to the insurance hosting system 18 and the contract between components in the insurance hosting system 18 can be verified statically. For example, there is certain information which the insurance hosting system 18 track that may be injected into the insurance product. A non-limiting example of such information that may be injected into the insurance product includes the current workflow state, which may be injected into the insurance product so that the correct forms are produced by the configured forms logic within the insurance product. As an example, new business forms are different from policy change forms so knowing the current workflow state, e.g., new business or policy change, facilitates the production of the correct forms.

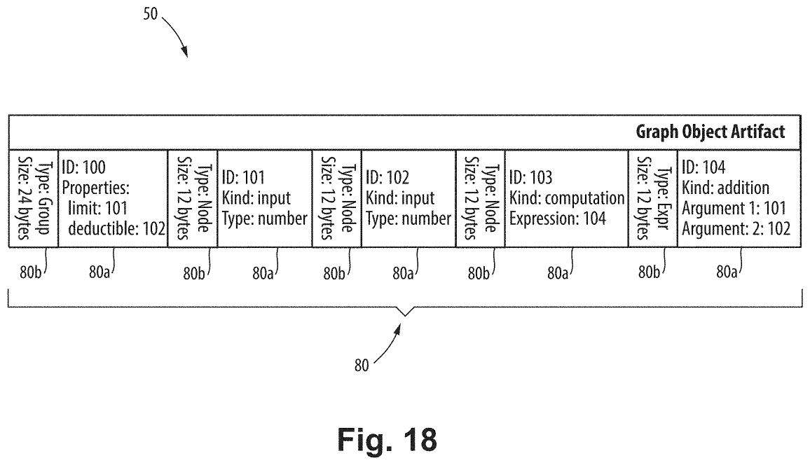

Continuing to refer to FIGS. 4 and 6, the output of the compiler 12 is a graph object artifact file 21 which is in a binary format that describes or represents the graph model 50, seen in FIG. 6, in terms of an execution model 52 and associated metadata 54. Each graph object artifact file 21 output by the compiler 12 may also be referred to herein as a graph object artifact 21. The graph object artifact 21 is described in more detail below. Non-limiting examples of metadata 54 include the original insurance semantics such as if nodes represent limits or deductibles and also information about where in the source code those elements are defined. For example, in FIG. 3 there is a line “limit LiabilityCoverageLimit: money” which declares the limit so the meta-data would have information about the line it appeared are defined. The execution model 52 does not directly encode any of the insurance semantics that are defined in the meta-model 30. The elements of the execution model 52 describe how to compute the values that are required to implement insurance product operations. The compiler 12 converts the instances of the data model 32 and behavior 34 defined within an insurance product 32a into the lower-level representation shown in FIG. 6 that, for example, the execution model 52 has groups 52a, nodes 52b and relations 52c, where a group 52a may contain nodes 52b and/or relations 52c. Entities 32c and features 32d, such as entities 32c, coverages 32e, conditions 32f, exclusions 32g and modifiers 32h, would be converted to groups 52a. Groups 52a represent execution model objects that have multiple named properties. Nodes 52b represent simple execution model values that either come from input data from an insurance policy, or are computed by expressions that access the values of other groups 52a and nodes 52b. Relations 52c represent an association between two groups 52a that may have a one-to-one, one to maybe on or a one-to-many correspondence. These constructs are organized into the graph object artifact 50 by the complier 12 as a stream of structured data 80 which can be serialized and/or deserialized. As seen in FIG. 18, this structured data 80 consists of a sequence of binary messages 80a that are prefixed with a size and message type 80b so that they can be read and interpreted by the compiler 12 and the execution engine 14.

For auditability purposes, it may be useful to be able to recalculate insurance product rates as they were originally calculated in the past. One exemplary way to recalculate insurance product rates is by treating each instance of an insurance product graph model 50 as immutable such that given the same input values, the immutable graph model 50, seen in FIG. 6, produces the same output values with the original semantics embedded along with the immutable graph model 50 as metadata 54. The immutable graph model 50 can be extended later to form a larger graph model 50 with additional computations without affecting the results of any pre-existing computations.

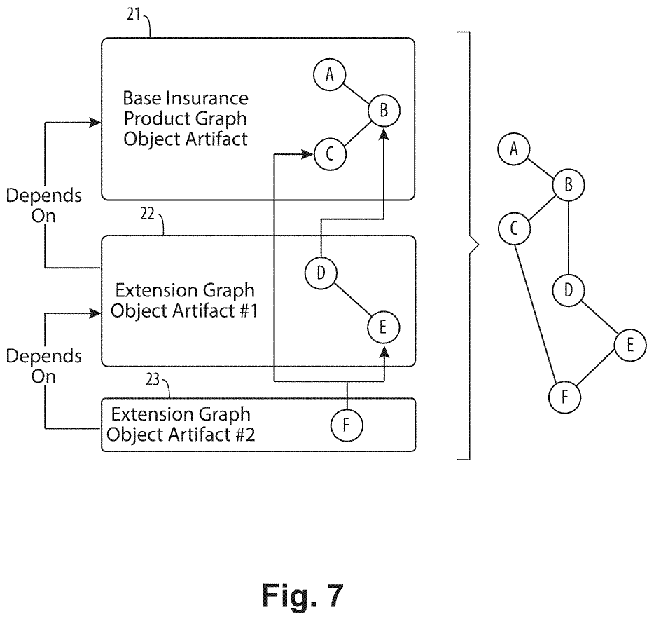

In addition, there may be other underwriting rules and insurance vendor data definitions that can change at a much faster pace than the immutable base insurance product 32a that do not affect the rates. It may be desirable to make changes related to underwriting rules, insurance vendor data definitions rules and/or other insurance product functionality without modifying the base insurance product. For the purpose of the present disclosure, the first compiled instance of a particular insurance product may also be referred to as the base insurance product. Further, since the output of the compiler 12 is a graph object artifact 21 that encodes the execution model 52 and the meta data 54, it is possible to treat the base graph object artifact 21 as a source that can populate the necessary internal state of the compiler 12 as if they were read from the original source code from which the base insurance product 32a was derived. The base graph object artifact 21 along with the source code associated with the particular extension (the “extension source code”) results in another graph object artifact that contains, and preferably only contains, the graph object emitted from compiling the extension source code. It is noted that since each graph object artifact 21 is a stream of structured data, reading two graph object artifacts, e.g., graph object artifact 21 and 22 in the correct order is essentially the same as reading a single graph object artifact, as shown in FIG. 7. If at a later stage, the extension source code changes, then the extension graph object artifact 23 could be compiled and re-released without re-releasing the base graph object artifact 21.

In the system 10 according to the present disclosure, it is possible to build an extension on top of another extension in a way that resembles layers. A non-limiting example of a use case for layering extensions is vendor data and underwriting rules extensions. In other words, it may be advantageous to have a first extension associated with vendor data as a first layer and a second extension associated with underwriting rules as a second layer. The vendor data layer allows data, e.g., data about risk exposures such as square footage for locations, to be enriched from third party sources and can provide a way to inject that data back into the insurance product data. For example, the system 10 can take or receive data feeds from vendors and use the data from such data feeds to enrich the data associated with an insurance policy, such as gathering data from vendor data feeds about a location once an address is entered into the system 10. Once insurance product data is enriched, the underwriting rules can compare the enriched insurance product data to actual data, e.g., manually entered data or non-derived data, and provide helpful hints to an underwriting team to flag areas which require more attention or approval. Therefore, multiple base graph object artifacts 21 can be provided when compiling the source code for an extension. More specifically, the extension source code can be compiled with the current base insurance products or base insurance products that have been compiled in the past. As a result, business rules can be maintained for all in-use insurance products. As noted above, base insurance products are immutable so any changes to an existing base insurance product causes the creation of a new base insurance product that is released, and when business rules in extensions are updated, the updated source code in the extension are compiled and the extension graph object artifacts 22 and/or 23 for one or more iterations of those base insurance products are deployed.

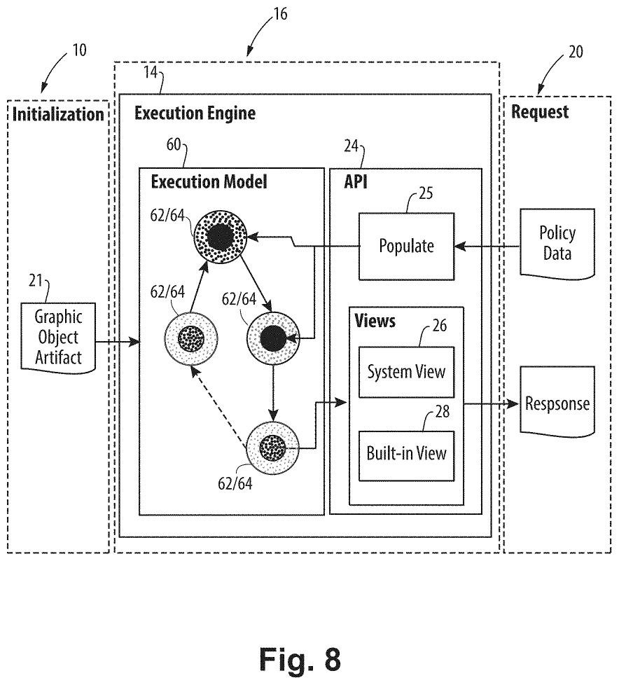

Referring now to FIG. 8, the execution engine 14 materializes the graph object artifact 21 so that the graph object artifact can be used to populate insurance product data stored in the insurance hosting system 18 and perform queries from users of the insurance hosting system 18. The execution engine 14 includes an execution model 60 and an application programming interface (API) 24 that allows the services 20 of the insurance hosting system 18 to communicate with the execution model 60 and to exchange data with the execution model 60. The execution model 60 is materialized from the graph object artifact 21 produced by the compiler 12, seen in FIG. 1.

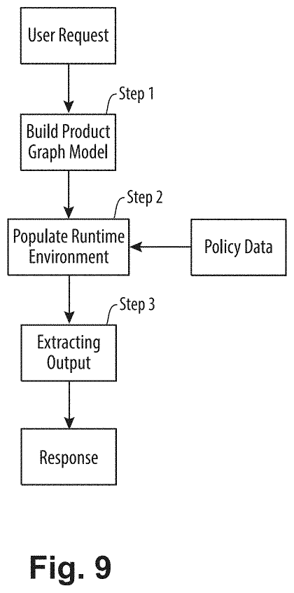

With reference to FIGS. 8-10, a non-limiting example of the process of the execution engine 14 for handling a user request input via a service 20 running on the insurance hosting system 18 is shown. The exemplary user request contains the data associated with a particular insurance policy or submission. A submission represents a potential future policy that may be issued to an insured party based on an application that has been submitted to the insurance carrier. The policy or submission data that is provided in a user request may also be referred to as the “policy snapshot.” In this example, the user request process includes building an instance of the execution model 60 from the graph object artifacts 21 output by the compiler 12 (Step 1). The execution model 60 according to the present disclosure is considered the specification of data processed by the execution engine 14. The execution engine instance environment 70, which is the transient in-memory data store contained within the execution engine 14 application memory, is then populated, via the populate 25 element, with insurance product data associated from the policy snapshot that is supplied by the insurance hosting system 18, third party data and/or data memoized from the computational results of the execution model 60. The execution engine environment according to the present disclosure is considered a specific instance of the execution model 60 populated with the insurance product data, third party data and/or memoized data from the computational results. Once the execution engine instance environment 70 has been populated with data as described above and shown in FIG. 10, the execution engine 14 extracts data from the execution engine instance environment 70, which may also be referred to herein as the execution engine environment output data, using system views 24 or built-in views 26. A view is a computation that is externally observable by users and systems within the insurance hosting system 18. As mentioned previously, these views typically perform aggregations of other computations which are not themselves directly visible outside of the execution engine 14. Non-limiting examples of the execution engine environment output data include rating results, policy document forms to render, validation results, and/or business rule flags. The execution engine 14 uses the execution engine environment output data to determine if additional data, e.g., insurance product data associated with the provided insurance policy that is supplied by the insurance hosting system 18, third party data and/or memoized data from the computational results, should be populated in the execution engine instance environment 70, or determines to have the execution model 60 run validation, pricing, retrieve underwriting flags, forms, etc. and these are exposed through API 24 as views 26 or 28. Views are implemented in one of two ways which is either by using system constructs creating a system view 26 or implemented as a built-in view 28. The system views 24 are a plurality of views that are implemented in the source code and compiled by the compiler 12 to a computational node in the directed graph. Non-limiting examples of system views 24 include rate views and custom views to extract information back into the insurance hosting system 18. Executing system views 24 in the execution engine 14 is similar to executing the computation nodes in the execution model 60. For example, computing a single rating or pricing component is similar to computing a system view 24 which contains main rating or pricing components. System views 24 can take advantage of the programming language, e.g., the domain specific language, constructs to aggregate other nodes in the directed graph. For example, the All[ ] aggregation defined above can search the execution model 50 for nodes that return a particular type requested. A non-limiting example of a rate view 26a implemented as a system view 26 is shown in FIG. 11. As shown, the execution model 60 includes a plurality of input nodes 62a and 62b and a plurality of computation nodes 64a-64f, where the computation nodes 64a-64f are executed to provide the rating or pricing result. More specifically, the rate view computation node 64a executes its associated expression which recursively executes computation nodes 64b-64d, which in turn requests input data from input nodes 62a and 62b previously populated in the execution engine instance environment 70. It is noted that computation nodes 64e and 64f of the execution model 60 are not executed as they are not needed for the rate view 26a. The execution engine instance environment 70 contains the input values supplied and the memoized computed values.

The built-in views 28 are a plurality of views that are implemented in the execution engine 14 and exist for all insurance products. Built-in views 28 are used when a view cannot be expressed in the source code because, for example, the built-in view needs an execution mode that is not expressible in source code or the built-in view needs access to data not exposed to the source code. Additionally, the built-in views 28 operate with the metadata from the compiled source code present so that the execution engine 14 knows how to interpret the computation nodes 64 in the execution model 60. Non-limiting examples of built-in views 28 include a rate view, a forms view, a validation view and a schema view which is currently used by the UI. A non-limiting example of a rate view 28a implemented as a built-in view 28 is shown in FIG. 12. As shown, the execution model 60 includes a plurality of input nodes 62a and 62b and a plurality of computational nodes 64a-64e in the execution model 60 that are executed to provide the individual rating and/or pricing components which are then aggregated into a single response. It is noted that computational nodes 64d and 64e of the execution model 60 are not executed as they are not needed for the built-in rate view 28a. The built-in rate view is querying metadata and the execution model 60 for all nodes which are of rate computation type, requesting their value, which in-turn get the required inputs from the populated execution engine instance environment 70. The values are then aggregated into a single response.

### Control Flow

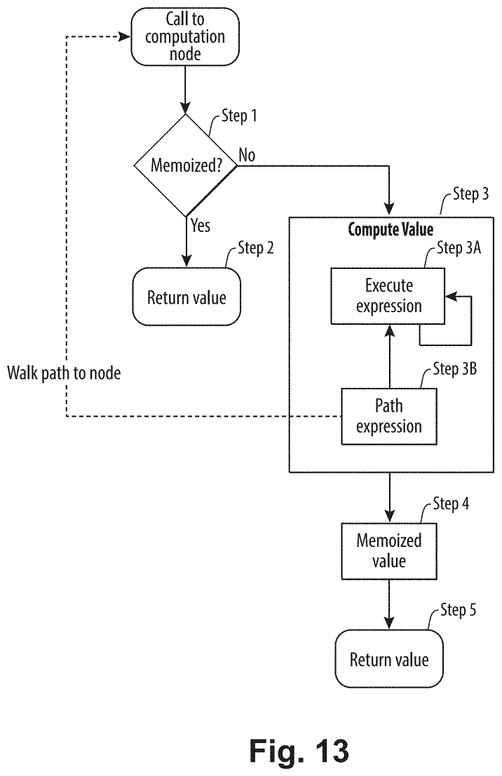

Referring now to FIG. 13, one of the principles of the programming language is that it is declarative, such that the desired result is described and the compiler 12 ensures the desired result can be produced. To achieve this, node 64 computations that depend on other node 64 computations or data model elements, seen in FIG. 2, are declared. FIG. 13 depicts a flow diagram for calling a computational node 64 in the execution model 60. When calling a computational node 64, the execution engine 14 checks to see if an execution engine instance environment 70 node value of the computation node 64 has been memoized (Step 1). If the execution engine 14 determines that an execution engine instance environment 70 node value of the computation node 64 has been memoized, the execution engine instance environment 70 node value is returned to the caller (Step 2). If the execution engine 14 determines that an execution engine instance environment 70 node value of the computational node 64 has not been memoized, the expression referenced by the called computational node 64 is computed (Step 3). More specifically, the execution engine 14 executes the expression referenced by the computational node 64 (Step 3A) and memoizes the execution engine instance environment 70 node value (Step 4). The memoized execution engine instance environment 70 node value is returned to the caller (Step 5). If the expression referenced by the called computational node 64 contains a path expression, the execution engine 14 calls the computational node 64 set forth in the path expression (Step 3B). For ease of description, the computational node 64 set forth in the path expression may also be referenced as the “path computational node.” When calling the path computational node 64, the execution engine 14 checks to see if an execution engine instance environment 70 node value of the path computational node 64 has been cached, i.e., memoized (Step 1). If the execution engine 14 determines that an execution engine instance environment 70 node value of the path computational node 64 has been memoized, the execution engine instance environment 70 node value is returned to the caller (Step 2). If the execution engine 14 determines that an execution engine instance environment 70 node value of the path computational node 64 has not been memoized, the expression referenced by the path computational node 64 is computed (Step 3). More specifically, the execution engine 14 executes the expression referenced by the path computational node 64 (Step 3A) and memoizes the execution engine environment node value (Step 4). The memoized execution engine environment node value is then returned to the caller (Step 5). If the expression referenced by the path computational node 64 contains another path expression, the process steps above are repeated. As can be readily seen, invoking a computation node 64 may implicitly invoke other computation nodes 64. It is noted that a path expression directs the execution engine 14 to traverse the execution model 60 to get the value of another computation node 64 in the execution model 60. Of course, traversing the execution model 60 is possible so long as the graph nodes and groups along the path defined by the particular path expression are valid.

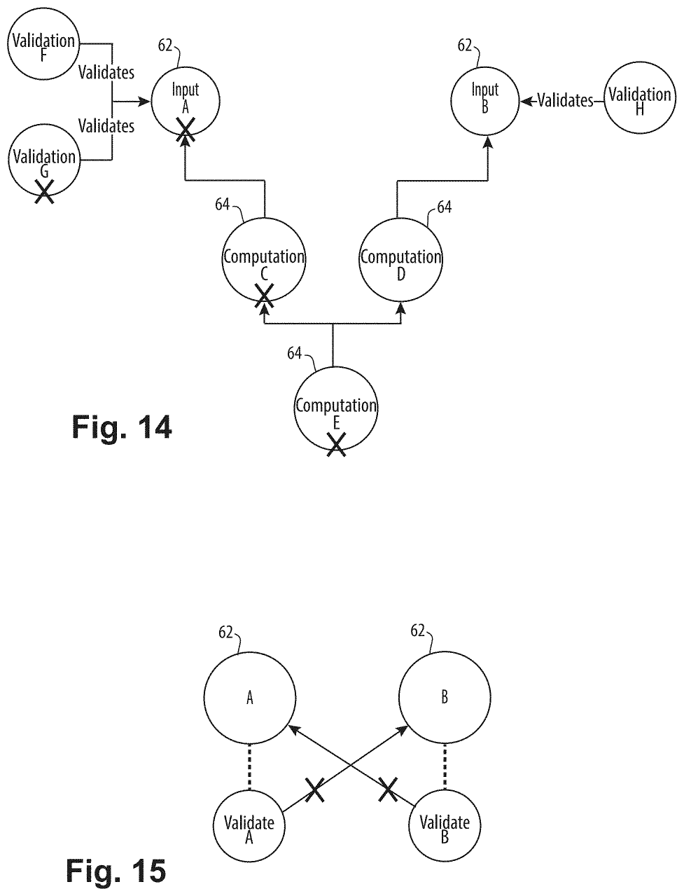

For the execution engine 14 to support partial computations, node validation may be built into the execution engine 14. With node validation, one or more of the nodes in the execution model 40 may be attached as validations to particular graph nodes and groups in the execution model 60. More specifically, when retrieving or computing an execution engine instance environment 70 node value of a path expression in a called computational node 64, the validation node will be run and if any of the validations return false, the value of the computational node 64 is invalidated and any dependent computational nodes of the computational node 64 are also invalidated. Validations are attached at various points in the graph model 50 and if any computation nodes have a dependency on an invalid node, then it will itself be invalid. These computation nodes which are invalid because of the invalid nodes are the dependents. FIG. 14 shows that an input node A has validation nodes F and G associated with it, and input node B has a validation node H associated with it. If, for example, validation G returns invalid (identified by the “X”), then input node A is invalid (identified by the “X”) and each dependent computation node associated with invalid input node A, here computation nodes C and E, are invalid (identified by the “X”).

One example where a validation can be returned false is that by default every field in the source code (defined by the programming language) may be required, but at execution time, every field in the source code may be optional. As a result, the compiler 12 will output validations for those fields marked as required such that if they are accessed and empty during execution time, the execution engine instance environment 70 node value is returned invalid, and the dependents will also be invalid. This allows source code to be written as if the data actually exists. If the source code type is optional then source code forces a non-case to be handled and not output a validation. Thus, when getting the result of a view 26 or 28, only valid results are returned to the API 24. This allows for partial computations when desired such as partial rating or running underwriting rules on partial submissions, etc. For example, if you consider a rating that may have multiple rating components, such as one for each location or vehicle, and there are some locations that are invalid because, for example, there is no square footage exposure entered, then it may be preferable to see the current rate even with this invalid location. This would permit underwriters to sometimes work on one line of business at a time and permits the underwriter to see preliminary rates as they build the submission. By using validations and the propagation of validation state as described permits such underwriter insight into preliminary rates.

If node validation is built into the execution engine 14, two exemplary modes to run under in the execution engine 14 can be utilized. The first mode is a “Safe” mode and the second mode is an “Unsafe” mode. When running the execution engine 14 in the Safe mode, if an invalid execution engine instance environment 70 node value is encountered by the execution engine 14, execution of the particular computational node 64 in the execution model 60 is preempted and the preempted computational node 64 is marked as invalid. All dependents from the invalid computational node 64 that try to access the invalid execution engine instance environment 70 node value are also marked as invalid. In the Safe mode, all restrictions, e.g., validation behaviors, on the execution model 60 produced by the compiler 12 are enforced. When running the execution engine 14 is in the Unsafe mode, each computational node 64 in the execution model 60 is executed until the end even if the dependencies are invalid and could potentially lead to unexpected results. It is noted that validation nodes can run in the Unsafe mode. This is so because the Unsafe mode ignores validations when executing computations. For example, and referring to FIG. 15, if there are two inputs nodes A and B, and the validation rule was that input A cannot equal input B, then the value of input A cannot be the same as the value of input B. Similarly, the value of input B cannot be the same as the value of input A. If the execution engine 14 were to execute this validation rule in Safe mode, then validating input A would try to validate input B due to the fact that the validation says the value of input A cannot be the same as the value of input B. The result is a circular dependency causing both input A and input B to be invalid (identified by the “X”). However, in the Unsafe mode, execution engine 14 ignores the validation rule and continues to execute the computational nodes 64.

It is common in the insurance industry for changes to occur to a particular insurance policy after the initial effective date of the insurance policy. There is therefore another time dimension that can be added to the meta-model 30 and the execution model 60, which is an effective time of the insurance policy. The effective time of the insurance policy is the time, in for example days, from the initial effective date of the insurance policy to the expiration date of the insurance policy when coverage is terminated. Additionally, if changes are made to a particular insurance policy, it may be useful to compare previous policy values. For example, certain parameters of an insurance policy, such as the limits and deductibles may change over time. A limit can change from, for example, $1 M to $2 M across an effective time period of the insurance policy. Such a change would need to be reflected in amended policy documents, so this effective time dimension should be visible from the DSL used to implement the insurance product.

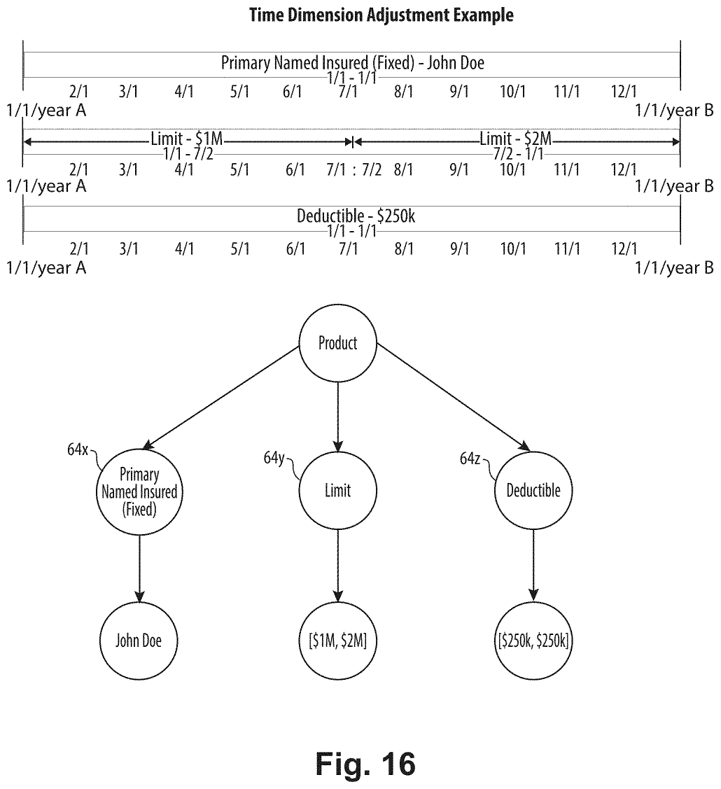

To account for these additional time dimensions, the execution model 60 may be adjusted in one or more ways. In an exemplary embodiment, the execution model 60 can be adjusted in two ways. First, each computational node 64 in the execution model 60 can be associated with a two dimensional matrix in the execution engine instance environment 70, and second, elements, e.g., data model and computation elements, shown in the meta-model 30 of FIG. 2, are permitted to be fixed across an effective time of the insurance policy. An example of accounting for the additional time dimensions is shown in FIG. 16. As shown, there is a single fixed value that cannot change over the term of the insurance policy and there are two values that can change over the term of the insurance policy. In the example shown in FIG. 16, the single fixed value in the primary named insured computational node 64x is John Doe. The limit computational node 64y, which is the coverage limit, was changed from $1 M to $2 M on July 2nd of year A to the end of term, here January 1 of year B so that the values associated with the limit node 64y are $1 M to $2 M. The deductible computational node 64z was not changed so that deductible value from January 1 of year A to the end of term, here January 1 of year B, remained at $250 K.

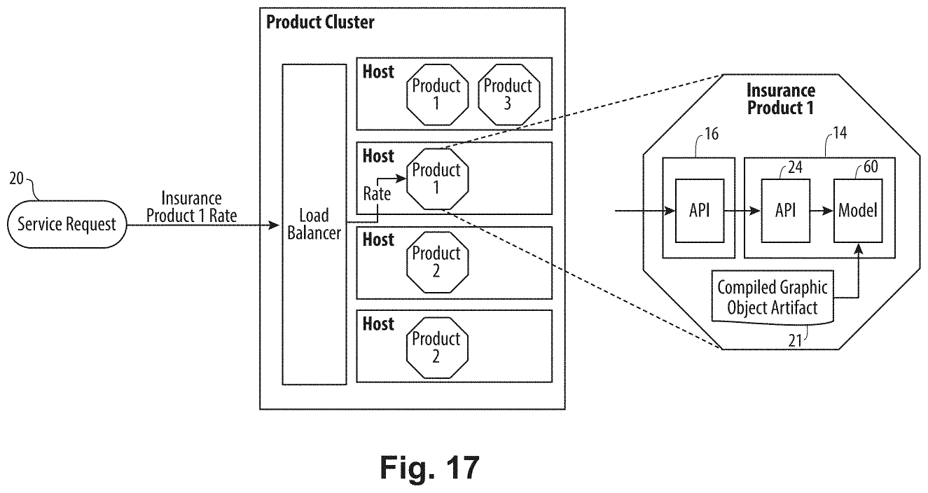

As noted above, the insurance products of the present disclosure are preferably immutable. As a result, when an insurance product is changed, the insurance product should be available to execute for a predefined period of time after the insurance product is made generally available to users. The predefined period of time may be mandated by insurance regulations, audit requirements and/or other requirements such that the predetermined period of time may be measured in terms of years. To address changes to the versions of an insurance product, the system 10 abstracts the version changes away from the insurance hosting system 18 such that consistent interfaces to each version of the insurance product through a single endpoint are available. Referring to FIG. 17, an example of such abstraction is shown. If there is a request from a service 20 of the insurance hosting system 18 to run the rate view for the given product data for an insurance product, e.g., Insurance Product 1, such request is routed to the correct host. It is noted that insurance product services are run within a container on a host. There may be many hosts, each running different insurance product services. To process the request from a service 20, the request is routed to the correct instance of the host for the insurance product, here the host for Insurance Product 1, which is responsible for running the graph object artifact 21 for that particular insurance product instance or version, here Insurance Product 1. Where the insurance products are running, how long they run for, and how many instances of the insurance products can be managed by a single control plane. These insurance products are started with the correct version of the execution model 60 and the product graph object artifacts 21.

### Extensions

Given that extensions allow mutability over an immutable base product, these changes need to be released in a controlled way. The infrastructure allows insurance product specifications (i.e., product+extensions artifacts) to be updated and will perform a rolling update of any currently running instances.

### Scalability & Multi-Tenancy

The system 10 can manage the number of instances of an insurance product centrally and allow the cluster to size up and down to handle the required load of all insurance products. Data between tenants can be sandboxed such that tenants can share the same underlying resources to reduce costs.

### Product Meta Store

Product graph object artifacts 21 are typically uploaded and catalogued ready to be used for a particular insurance hosting system 18. For this purpose, there may be an insurance product meta-data store which tracks all insurance products and stores meta-data about the insurance products in a persistent database. This information can be used by the execution engine 14 to govern what insurance products to run and how to run them. The product meta-data store also provides a mechanism for insurance product selection, such that various insurance hosting system 18 services can select the correct insurance product before making calls to it. The product cluster contains servers/hosts which are partitioned into running specific insurance product services. These services consist of a web-based runtime environment 16, e.g., an HTTP application, the execution engine 14 and the graph object artifacts 21. A request to a specific product view is routed by the product cluster infrastructure.

What is claimed is:

1. A system for representing insurance products as directed graphs and transforms the directed graphs into graph object artifacts for execution, the system comprising:
a compiler that transforms source code defining an insurance product as a directed graph into a plurality of nodes, each node representing one of a computation and an input, and outputs a graph object artifact; and
an execution engine having an execution model derived from the graph object artifact that is loaded into memory and an application program interface that provides an interface to a web-based runtime environment, wherein the web-based runtime environment provides a layer of abstraction between the execution engine and external services.

2. The system according to claim 1, wherein the directed graph is defined using a meta-model.

3. The system according to claim 2, wherein the meta-model comprises a data model, at least one behavior component and at least one compute type.

4. The system according to claim 3, wherein the data model comprises structured data that is capable of being injected into the meta-model, the structured data includes a type of insurance product, a line of business associated with the insurance product, an entity associated with the insurance product, at least one feature associated with the insurance product, and one or more bounds associated with the insurance product.

5. The system according to claim 3, wherein the at least one behavior component includes at least one computation element used to output a numeric value or structured data associated with the at least one compute type.

6. The system according to claim 1, wherein the compiler performs a series of transformations on the source code to output the graph object artifact, the series of transformations include:
a parsing transformation parsing the source code grammar into an abstract syntax tree;
a code generation transformation on the parsed source code;
a type checking transformation on the source code generated by the code generation transformation;
a scope resolution transformation on the source code; and
an insurance hosting system transformation on the source code.

7. The system according to claim 1, wherein the execution model comprises at least one input node and at least one computation node.

8. The system according to claim 1, wherein the execution engine includes an execution engine environment populated with data associated with the insurance product, and an association of the execution engine environment data to the execution model, and wherein the execution engine executes a view that is externally observable via the web-based runtime environment.

9. A system for representing insurance products as directed graphs and transforms the directed graphs into graph object artifacts for execution, the system comprising:
a compiler that transforms source code defining an insurance product as a directed graph into a plurality of nodes, each node representing one of a computation and an input, and outputs a graph object artifact; and
an execution engine having an execution model derived from the graph object artifact that is loaded into memory and an application program interface that provides an interface to a web-based runtime environment, wherein the web-based runtime environment provides a layer of abstraction between the execution engine and an insurance hosting system.

10. The system according to claim 9, wherein the directed graph is defined using a meta-model.

11. The system according to claim 10, wherein the meta-model comprises a data model, at least one behavior component and at least one compute type.

12. The system according to claim 11, wherein the data model comprises structured data that is capable of being injected into the meta-model, the structured data includes a type of insurance product, a line of business associated with the insurance product, an entity associated with the insurance product, at least one feature associated with the insurance product, and one or more bounds associated with the insurance product.

13. The system according to claim 11, wherein the at least one behavior component includes at least one computation element used to output a numeric value or structured data associated with the at least one compute type.

14. The system according to claim 9, wherein the compiler performs a series of transformations on the source code to output the graph object artifact, the series of transformations include:
a parsing transformation parsing the source code grammar into an abstract syntax tree;
a code generation transformation on the parsed source code;
a type checking transformation on the source code generated by the code generation transformation;
a scope resolution transformation on the source code; and
an insurance hosting system transformation on the source code.

15. The system according to claim 9, wherein the execution model comprises at least one input node and at least one computation node.

16. The system according to claim 9, wherein the execution engine includes an execution engine environment populated with data associated with the insurance product, and an association of the execution engine environment data to the execution model, and wherein the execution engine executes a view that is externally observable at the insurance hosting system via the web-based runtime environment.
